(19) United States
(12) Patent Application Publication
(10) Pub. No.: US 2014/0037986 A1
(43) Pub. Date: Feb. 6, 2014

(54) NICKEL-BASED BRAZING METAL POWDER FOR BRAZING BASE METAL PARTS WITH REDUCED EROSION

(71) Applicants: Michael Weinstein, Los Lunas, NM (US); Eric Krosche, Albuquerque, NM (US); Lydia W. Lee, Troy, MI (US); Christopher Jacob Skinner, Albuquerque, NM (US)

(72) Inventors: Michael Weinstein, Los Lunas, NM (US); Eric Krosche, Albuquerque, NM (US); Lydia W. Lee, Troy, MI (US); Christopher Jacob Skinner, Albuquerque, NM (US)

(21) Appl. No.: 13/956,673

(22) Filed: Aug. 1, 2013

Related U.S. Application Data
(60) Provisional application No. 61/678,737, filed on Aug. 2, 2012.

(51) Int. Cl. B23K 35/30; B32B 15/01; B23K 35/02

(52) U.S. Cl. CPC B23K 35/3033; B23K 35/0244; B23K 35/025; B32B 15/011
USPC 428/679; 75/255; 75/228; 148/22; 419/1; 228/101; 228/219

(57) ABSTRACT

A brazing filler metal powder is provided for brazing thin stainless steel parts together with reduced erosion. The brazing filler metal powder is formed by processing first metal particles, which typically comprise a nickel-based alloy including chromium, phosphorous, silicon, to a particle size of not greater than 0.0098 inch; providing second metal particles, typically consisting of copper, molybdenum, or cobalt; combining the first metal particles with the second metal particles by mixing and/or, milling, or sintering; and processing the combined composition to a particle size of not greater than 0.0098 inch. The first and second metal particles are less than fully alloyed together and are distinct from one another. A preferred composition of the brazing filler metal powder is 26.1 wt. % chromium, 5.4 wt. % phosphorous, 5.9 wt. % silicon, 10.0 wt. % cobalt, and a balance essentially of nickel.

### CROSS REFERENCE TO RELATED APPLICATIONS

This U.S. utility patent application claims priority to U.S. provisional patent application Ser. No. 61/678,737, filed Aug. 2, 2012, the entire content of which is hereby incorporated by reference in its entirety.

### BACKGROUND OF THE INVENTION

1. Field of the Invention

The invention relates generally to a nickel-based brazing filler metal powder, a brazing material including the brazing filler metal powder, a brazed assembly including the brazing filler metal powder, and methods of forming the same.

2. Related Art

Nickel-based brazing filler metal powders are used to braze metal parts (referred to as base metals) together for the purpose of achieving a strongly joined brazed assembly. Exemplary nickel-based brazing filler metal powders include the Nicrobraz® alloys sold by Wall Colmonoy Corporation. Such brazing filler metal powders facilitate the mass production of heat exchangers, including, but not limited, to exhaust gas recirculation (EGR) coolers and catalytic converters. The brazing filler metal powders form a braze joint providing suitable mechanical integrity, strength, and chemical resistance, and thus an acceptable service life.

Heat exchangers including the brazed joints are typically formed of stainless steel, rather than copper or aluminum, due to the strength and corrosion resistance of stainless steel. However, stainless steel has a relatively low thermal conductivity, compared to copper or aluminum. Thus, the stainless steel heat exchangers are typically designed with thin parts, such as thin walled tubes or sections, for example walls or sections having a thickness of 0.001 inch to 0.010 inch, to attain suitable heat transfer performance.

Although the thin stainless steel parts provide improved heat transfer performance, they oftentimes experience undesirable erosion by the molten filler metal during the brazing process. The erosion phenomenon is a microstructural and compositional transformation of the original base metal into a localized alloy that does not have the same mechanical and corrosion resistance properties. Due to the geometry of the parts there is an excess of brazing filler metal where the brazing metal is applied. When the brazing metal is heated to a liquid state the brazing filler metal flows along the joint and fills the area along the joint by capillary action. Diffusion related interactions between the stainless steel and the excess brazing metal in the liquid state causes the erosion at or adjacent to the joint, and thus reduces the thickness of the stainless steel part. The reduced thickness, which is most prevalent when there is an excess of filler metal present, creates a weak area which can reduce the service life of the heat exchanger.

### SUMMARY OF THE INVENTION

The invention provides a brazing filler metal powder for brazing stainless steel parts with reduced erosion along the joint area during the brazing process, while maintaining exceptional joint strength and corrosion resistance. The brazing filler metal powder comprises a plurality of first metal particles, which can also be referred to as first brazing filler metal particles, combined with a plurality of second metal particles, which can also be referred to as a second metal component and is generally an elemental or pure metal, such that the first metal particles and the second metal particles are distinct from one another and are less than fully alloyed together. The first metal particles include 13.0 wt. % to 45.0 wt. % chromium, 0.0 wt. % to 12.0 wt. % phosphorous, 0.0 wt. % to 12.0 wt. % silicon, 0.0 wt. % to 6.0 wt. % boron, 0.0 wt. % to 15.0 wt. % iron, and at least 41.0 wt. % nickel, based on the total weight of the first metal particles. The second metal particles consist of at least one of copper, molybdenum, cobalt, chromium, and alloys thereof. In addition, the first metal particles and the second metal particles have a particle size of not greater than 0.0098 inch (60 US and Tyler Mesh, 0.250mm). Another aspect of the invention provides a method of forming the brazing filler metal powder. The method includes providing a plurality of the first metal particles having a particle size of not greater than 0.0098 inch (60 US and Tyler Mesh, 0.250 mm); providing a plurality of the second metal particles having a particle size of not greater than 0.0098 inch (60 US and Tyler Mesh, 0.250 mm); and combining the first metal particles with the second metal particles.

The invention also provides for using the brazing filler metal powder as a brazing material for brazing stainless steel or other base metal parts together. The brazing material includes the combination of the first metal particles and the second metal particles. The brazing material is either in a powder form or alternative form which facilitates application. For example, the brazing filler metal powder can be combined with a binder. Another aspect of the invention provides a method of forming the brazing material. The method comprises the steps of providing the brazing filler metal powder, and combining the brazing filler metal powder with the binder.

The invention also provides a brazed assembly. The brazed assembly comprises a first metal part formed of stainless steel and a second metal part formed of stainless steel. The second metal part is joined to the first metal part by the brazing filler metal powder. Another aspect of the invention provides a method of forming the brazed assembly. The method comprises brazing the first metal part formed of stainless steel to the second metal part formed of stainless steel with the brazing filler metal powder.

During the process of brazing the brazing filler metal powder is heated to the liquid state, the second metal particles consisting of at least one of copper, molybdenum, cobalt, chromium, and alloys thereof form a diffusion reservoir. This diffusion reservoir provides a diffusion path for the silicon, or the other elements, alternate to the diffusion path provided by the base metal parts. The second metal particles therefore reduce the diffusion rate of the silicon, or other elements, into the base metal parts, which in turn reduces erosion of the base metal parts.

### BRIEF DESCRIPTION OF THE DRAWINGS

Other advantages of the present invention will be readily appreciated, as the same becomes better understood by reference to the following detailed description when considered in connection with the accompanying drawing wherein:

FIG. 1 is a photomicrograph taken during a process of forming a brazing filler metal powder illustrating first metal particles with cobalt (the second metal particles) mechanically clad during the processes;

FIG. 2 is a photomicrograph showing the first and second metal particles after a processing time five times longer than the processing time of FIG. 1;

FIG. 3 is a photomicrograph of an agglomeration including the first and second metal particles of FIGS. 1 and 2;

FIG. 4 is a photomicrograph of an inventive brazing filler metal powder joining two stainless steel parts, and

FIG. 5 is a photomicrograph of a comparative brazing filler metal powder joining two stainless steel parts.

### DETAILED DESCRIPTION

The invention comprises a nickel-based brazing filler metal powder for brazing stainless steel parts, such as thin parts, for example heat exchangers with thin sections or thin walled tubes. The present nickel-based brazing filler metal material provides reduced erosion along the joint area during the brazing process, compared to other nickel-based brazing filler metals, while maintaining exceptional joint strength and corrosion resistance. The brazing filler metal powder is formed by combining a plurality of first metal particles, also referred to as a filler metal powder, with a plurality of second metal particles, also referred to as a non-filler metal powder, each having a particle size not greater than 0.0098 inch (60 US and Tyler Mesh, 0.250 mm). The first metal particles and the second metal particles are mechanically or metallurgically combined. However, after the combining step, the first metal particles and the second metal particles remain distinct from one another and are less than fully alloyed together. For example, the solid, dry, first metal particles and the solid, dry second metal particles could be mixed together, agglomerated together with a binding agent, spray dried with a binding agent, sintered, or combined by milling. The combined composition is then processed to a particle size of not greater than 0.0098 inch (60 US and Tyler Mesh, 0.250 mm), and thus is suitable for a subsequent furnace brazing process.

The first metal particles of the brazing filler metal powder comprise an alloy including 13.0 wt. % to 45.0 wt. % chromium, 0.0 wt. % to 12.0 wt. % phosphorous, 0.0 wt. % to 12.0 wt. % silicon, 0.0 wt. % to 6.0 wt. % boron, 0.0 wt. % to 15.0 wt. % iron, and at least 41.0 wt. % nickel, based on the total weight of the first metal particles. In one embodiment, the first metal particles include 15.0 wt. % to 36.0 wt. % chromium, at least 3.0 wt. % phosphorous, and at least 3.0 wt. % silicon, based on the total weight of the first metal particles. The first metal particles also preferably include less than 15.0 wt. % cobalt and less than 15.0 wt. % iron. In another embodiment, the first metal particles include 5.0 wt. % to 15.0 wt. % iron, based on the total weight of the first metal particles. An alloy of chromium, silicon, and phosphorous is oftentimes preferred because silicon and phosphorous are strong melting point depressants, and because silicon and chromium enhance corrosion resistance. The first metal particles also have a particle size of not greater than 0.0097 inch (60 US and Tyler Mesh, 0.250 mm) Exemplary metal alloys for use as the first metal particles are sold by Wall Colmonoy Corporation under the name Nicrobraz®. The compositions listed in Table 1 are provided in wt. %, based on the total weight of the first metal particles.

TABLE 1

| Exemplary First | | | | | | | |
|---|---|---|---|---|---|---|---|
| Metal Particles | Cr | P | Si | Fe | C | B | Ni |
| Nicrobraz ® 125 | 14.0 | 0.0 | 4.5 | 4.5 | 0.7 | 3.0 | balance |
| Nicrobraz ® L.C. | 14.0 | 0.0 | 4.5 | 4.5 | 0.06 max | 3.0 | balance |
| Nicrobraz ® L.M. | 7.0 | 0.0 | 4.5 | 3.0 | 0.06 max | 3.1 | balance |
| Nicrobraz ® 30 | 19.0 | 0.0 | 10.2 | 0.0 | 0.06 max | 0.0 | balance |
| Nicrobraz ® 31 | 22.0 | 4.5 | 6.5 | 0.0 | 0.0 | 0.0 | balance |
| Nicrobraz ® 33 | 29.0 | 6.0 | 6.5 | 0.0 | 0.0 | 0.0 | balance |
| Nicrobraz ® 152 | 30.0 | 6.0 | 4.0 | 0.0 | 0.0 | 0.0 | balance |
| Nicrobraz ® 50 | 14.0 | 10.0 | 0.0 | 0.0 | 0.06 max | 0.0 | balance |
| Nicrobraz ® 51 | 25.0 | 10.0 | 0.0 | 0.0 | 0.0 | 0.0 | balance |
| Nicrobraz ® 150 | 15.0 | 0.0 | 0.0 | 0.0 | 0.06 max | 3.5 | balance |
| Nicrobraz ® 920 | 26.6 | 7.0 | 3.6 | 0.0 | 0.0 | 0.0 | balance |

The second metal particles used to form the brazing filler metal powder consist of at least one of copper, molybdenum, cobalt, chromium, and alloys thereof. In preferred embodiments, the second metal particles are elemental powders and consist of cobalt or molybdenum. The second metal particles could alternatively include a combination of elemental cobalt and elemental molybdenum. The brazing filler metal powder is typically formed from 70.0 wt. % to 95.0 wt. % of the first metal particles and 1.0 wt. % to 30.0 wt. % of the second metal particles, but preferably at least 5.0 wt. % of the second metal particles, based on the total weight of the brazing filler metal powder.

In one embodiment, the second metal particles include cobalt, and the overall brazing filler metal powder composition includes 1.0 wt. % to 25.0 wt. % cobalt, based on the total weight of the brazing filler metal powder. In another embodiment, the second metal particles include molybdenum, and the brazing filler metal powder includes 1.0 wt. % to 25.0 wt. % molybdenum, based on the total weight of the brazing filler metal powder. In yet another embodiment, the second metal particles include copper, and the brazing filler metal powder includes 1.0 wt. % to 25.0 wt. % copper, based on the total weight of the brazing filler metal powder. In another embodiment, the brazing filler metal powder includes a combination of copper, molybdenum, and cobalt in a total amount of 1.0 wt. % to 15.0 wt. %, based on the total weight of the brazing filler metal powder.

The composition of the finished brazing filler metal powder depends on the combined composition of the first metal particles and the second metal particles. In one preferred embodiment, the finished brazing filler metal powder consists of 26.1 wt. % chromium, 5.4 wt. % phosphorous, 5.9 wt. % silicon, 10.0 wt. % cobalt, and a balance essentially of nickel. The balance essentially of nickel could include 100.0 wt. % nickel, or could include substantially nickel with unavoidable or incidental impurities. Table 2 below provides exemplary brazing filler metal powders, which are formed from the first metal particles and the second metal particles. Each of the powders listed in Table 2 have a particle size of not greater than 0.0098 inch (60 US and Tyler Mesh, 0.250 mm). The compositions listed in Table 2 are also provided in wt. %, based on the total weight of the brazing filler metal powder.

TABLE 2

| Exemplary Brazing | | | | | | |
|---|---|---|---|---|---|---|
| Filler Metal Powders | Cr | Si | P | Cu | Mo | Co |
| Composition A | 29.0 | 6.5 | 6.0 | 0.0 | 0.0 | 0.0 |
| Composition B | 25.3 | 3.8 | 6.7 | 5.0 | 0.0 | 0.0 |
| Composition C | 24.0 | 3.2 | 6.3 | 10.0 | 0.0 | 0.0 |
| Composition D | 22.6 | 3.1 | 6.0 | 15.0 | 0.0 | 0.0 |
| Composition E | 21.3 | 2.9 | 5.6 | 20.0 | 0.0 | 0.0 |
| Composition F | 27.6 | 3.7 | 5.5 | 0.0 | 4.0 | 0.0 |
| Composition G | 27.0 | 3.6 | 5.4 | 0.0 | 6.0 | 0.0 |
| Composition H | 26.1 | 5.9 | 5.4 | 0.0 | 0.0 | 10.0 |

The invention also provides a method of forming the brazing filler metal powder. The method includes providing the first metal particles, and processing the first metal particles to a particle size of not greater than 0.0098 inch (60 US and Tyler Mesh, 0.250mm) The first metal particles are typically produced by atomization and then sized to a particle size of not greater than 60 Tyler mesh. Alternatively, the process can include providing a first metal, which is not in particle form, and processing the first metal to first metal particles having a particle size of not greater than 0.0098 inch (60 US and Tyler Mesh, 0.250 mm). The processing step can comprise a variety of different techniques, for example milling, grinding, or crushing. The method also includes providing the second metal particles consisting of at least one of copper, molybdenum, cobalt, chromium, and alloys thereof The method also typically includes processing the second metal particles to a particle size of not greater than 0.0098 inch (60 US and Tyler Mesh, 0.250 mm). Alternatively, the process can include providing a second metal, which is not in particle form, and processing the second metal to second metal particles having a particle size of not greater than 0.0098 inch (60 US and Tyler Mesh, 0.250 mm).

Next, the method includes combining the first metal particles and the second metal particles together. The combining step can include mechanically or metallurgically combining the first metal particles and the second metal particles, and various different processing techniques can be used. In one embodiment, the first metal particles and second metal particles are admixed together, and the particles are solid and dry during the mixing step. The mixing step is typically conducted in a batch mixer. In yet another embodiment, the combining step includes milling the solid, dry first metal particles and the solid, dry second metal particles together to form a partial mechanical alloy or mechanical agglomeration.

In another embodiment, the method includes mixing the solid, dry first metal particles and the solid, dry second metal particles together with a binding agent in a batch mixer to form an agglomeration. Various different binding agents can be used to agglomerate the first metal and the second metal, for example a solvent or water-based material, or a liquid plastic material. Exemplary liquid plastic binding agents include Nicrobraz® Cement 510 or Nicrobraz® Cement 520, which are sold by Wall Colmonoy Corporation. The liquid plastic binding agents have the capacity to leave no detrimental residues during a subsequent furnace brazing process. Alternatively, the combining step can include spray drying the first metal particles and the second metal particles together with a binding agent.

In another embodiment, the combining step includes sintering the solid, dry first metal particles and the solid, dry second metal particles together in an atmospherically controlled furnace. For example, the sintering step can be conducted in a vacuum at a pressure of not greater than 10⁻³ ton and a temperature of about 1,300° F. to about 1,800° F.

In each embodiment, the combining step typically includes combining 70.0 wt. % to 95.0 wt. % of the first metal particles and 1.0 wt. % to 30.0 wt. % of the second metal particles, based on the total weight of the combined particles, but different amounts of the first metal particles and the second metal particles could be used. When the first metal particles and the second metal particles are combined, the first metal particles and the second metal particles are attached to one another. However, the first metal particles and the second metal particles remain distinct from one another, such that the two different particles can be identified as distinct compositions under a microscope. The combined first and second metal particles can also be referred to as mechanically alloyed or a mechanical admixture. However, the first metal particles and second metal particles are only partially alloyed, and they are less than fully alloyed. If the first metal particles were fully alloyed, the result would be a homogenous mixture of the first metal and the second metal. However, when the first metal particles and the second metal particles are only partially alloyed, only a portion of the first and second metal particles form a homogeneous mixture. During the combining step, the particles are not melted to a liquid state and thus do not become fully alloyed. Typically, less than 50% of the total amount of first metal particles and second metal particles are alloyed together and form a mixture.

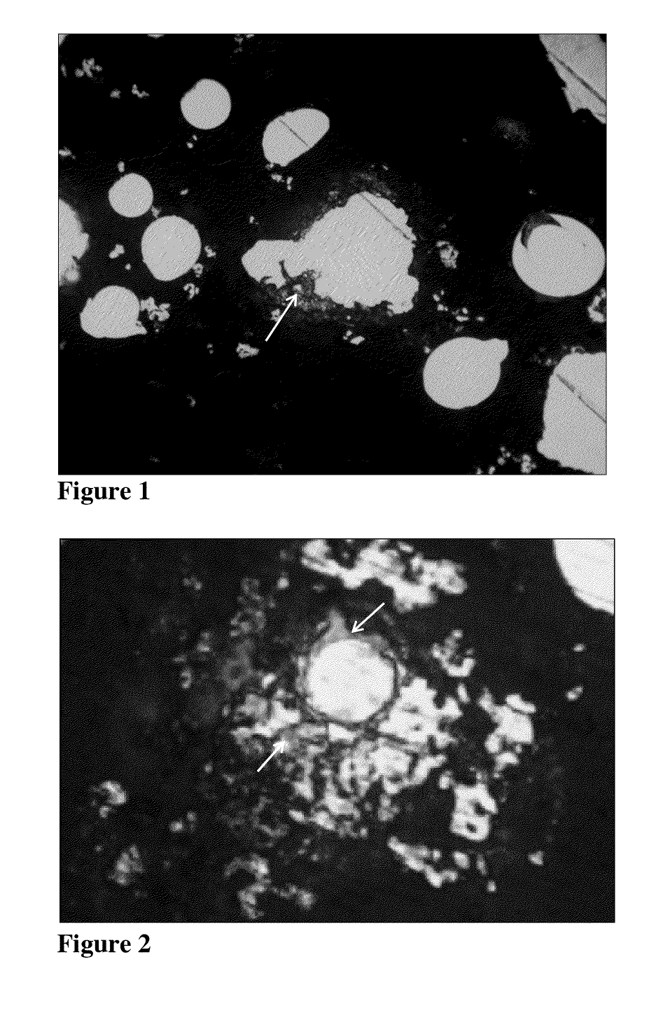

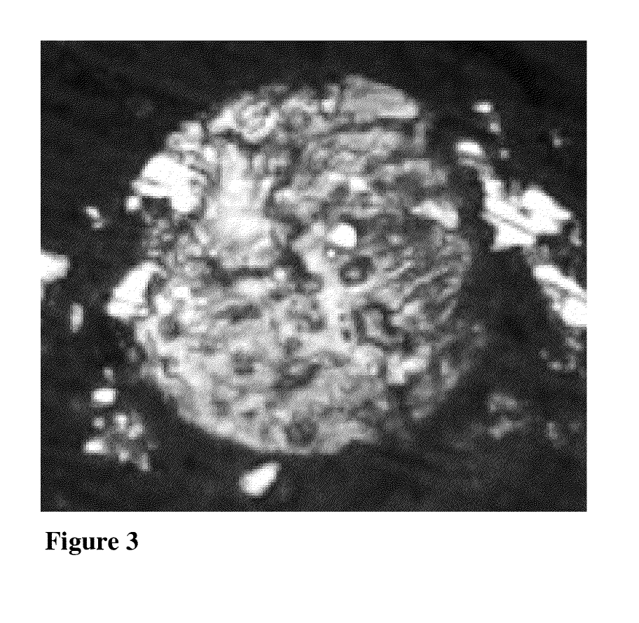

FIG. 1 is a photomicrograph taken during an exemplary process of forming the brazing filler metal powder, shortly after the first metal particles and the second metal particles were combined together by milling. In the exemplary embodiment of FIG. 1, the first metal particles comprise an alloy of chromium, silicon, phosphorous, and nickel; and the second metal particles consist of cobalt. FIG. 1 also includes arrows showing the cobalt particles mechanically clad to the first metal particles. FIG. 2 is a photomicrograph of the cobalt mechanically clad to the first metal particles after a processing time which is five times longer than the processing time of FIG. 1. FIG. 2 also includes arrows showing the cobalt mechanically clad to the first metal particles. FIG. 3 is a photomicrograph of an agglomeration including the first metal particles and the second metal particles consisting of cobalt.

After the first metal particles and the second metal particles are combined together, the method includes processing the agglomeration or combined first metal particles and second metal particles to a particle size of not greater than 0.0098 inch (60 US and Tyler Mesh, 0.250 mm) This processing step can include a variety of different techniques, for example milling, grinding, or crushing. The technique used to process the combined particles or agglomeration can be the same technique used to process and reduce the particle size of the first metal and the second metal prior to the combining step. In any event, the finished brazing filler metal powder includes the first metal and the second metal combined together, and the finished brazing filler metal powder has a particle size of not greater than 0.0098 inch (60 US and Tyler Mesh, 0.250 mm). In other words, the first metal particles and the second metal particles present in the finished brazing filler metal powder each have a particles size of not greater than 0.0098 inch (60 US and Tyler Mesh, 0.250 mm).

The invention also provides a brazing material including the brazing filler metal powder. The brazing material is subsequently used to braze metal parts together, especially parts formed of stainless steel. In one embodiment, the brazing material consists entirely of the brazing filler metal power. For example, the brazing material can comprise a rod or a pre-form prepared by sintering the brazing filler metal powder.

Alternatively, the brazing material can include a binder and be provided in the form of a paste, a transfer tape, or a transfer sheet. The binder can include a variety of different materials known in the art, such as a gel or an acrylic. In one embodiment, the brazing material is in the form of a paste and comprises 70.0 to 95.0 wt. % brazing filler metal powder and a balance essentially of the binder, based on the total weight of the brazing material. In another embodiment, the brazing material comprises 84.0 wt. % to 90.0 wt. % brazing filler metal powder and a balance essentially of the binder. The binder used to form the paste is a gel or a liquid/gel binder system. The paste facilitates application to brazement assemblies by pneumatic, hydrostatic, or positive displacement methods.

In another embodiment, the brazing material is in the form of a transfer tape or transfer sheet and comprises at least 75.0 wt. % brazing filler metal powder and a balance essentially of the binder, based on the total weight of the brazing material. The binder used to form the transfer tape or sheet is typically a dried binder system, for example an acrylic type which imparts desired strength and does not inhibit furnace brazing operations.

The invention also provides a method of forming the brazing material for brazing stainless steel parts. The method comprises the steps of providing the brazing filler metal powder, and combining the brazing filler metal powder with the at least one binder. In one embodiment, the step of combining the brazing filler metal powder with the at least one binder includes forming the paste, the transfer tape, or the transfer sheet.

Another aspect of the invention is a brazed assembly formed using the brazing filler metal powder. The brazed assembly comprises a first metal part formed of stainless steel, and a second metal part formed of stainless steel. The metal parts are joined together by the brazing material, which can consist entirely of the brazing filler metal powder, or can include a binder or other components, in addition to the brazing filler metal powder. The brazing filler metal powder provides especially good results when used to join thin parts, for example wherein at least one of the first metal part and the second metal part has a thickness of 0.001 to 0.010 inch. In one embodiment, at least one of the first metal part and the second metal part has a thickness of less than 0.010 inch, or not greater than 0.003 inch thick. In a preferred embodiment, the brazing filler metal powder is used to form a stainless heat exchanger having thin walled tubes or sections, for example walls or sections being only 0.003 inch thick.

The method of forming the brazed assembly includes brazing the first metal part formed of stainless steel to the second metal part formed of stainless steel with the brazing filler metal powder. The brazing step is typically conducted in a furnace at an atmosphere suitable for brazing, including a suitable pressure, temperature, and oxygen level. The temperature during the brazing process is high enough to melt the brazing filler metal powder, but not high enough to melt the base metal parts.

Experiment 1

An experiment was conducted to test the erosion resistance of an exemplary inventive brazing filler metal powder, specifically Composition H of Table 2, and compare the erosion resistance of Composition H to the erosion resistance of a comparative brazing filler metal powder. Composition H was formed from first metal particles consisting of chromium, silicon, phosphorous, and a balance essentially of nickel; and second metal particles consisting of cobalt. The first metal particles were processed to a particle size of not greater than 0.0098 inch and combined with the second metal particles, also having a particle size of not greater than 0.0098 inch, by milling, to form an agglomeration. The agglomeration was then processed to a particle size of not greater than 0.0098 inch. The finished composition of the inventive brazing filler metal powder included 26.1 wt. % chromium, 5.9 wt. % silicon, 5.4 wt. % phosphorous, and 10.0 wt. % cobalt, based on the total weight of the inventive brazing filler metal powder, and the brazing filler metal powder had a particle size of not greater than 250.0 micrometers.

The comparative brazing filler metal powder included 9.0 wt. % chromium, 6.5 wt. % silicon, and 6.0 wt. % phosphorous, an a balance essentially of nickel, based on the total weight of the comparative brazing filler metal powder. The comparative brazing filler metal powder also had a particle size of not greater than 250.0 micrometers.

The inventive and comparative brazing filler metal powders were each heated to a temperature of 1950° F. and used to braze two stainless steel parts together. The stainless steel parts brazed together by the inventive brazing filler metal powder had the same dimensions as the stainless steel parts brazed together by the comparative brazing filler metal powder. In each case, one of the stainless steel parts was a turbulator fin having a section thickness of only 0.003 inch. The thickness of the tube was measured before and after the brazing process, and the difference in thickness indicated the extent of erosion during the brazing process.

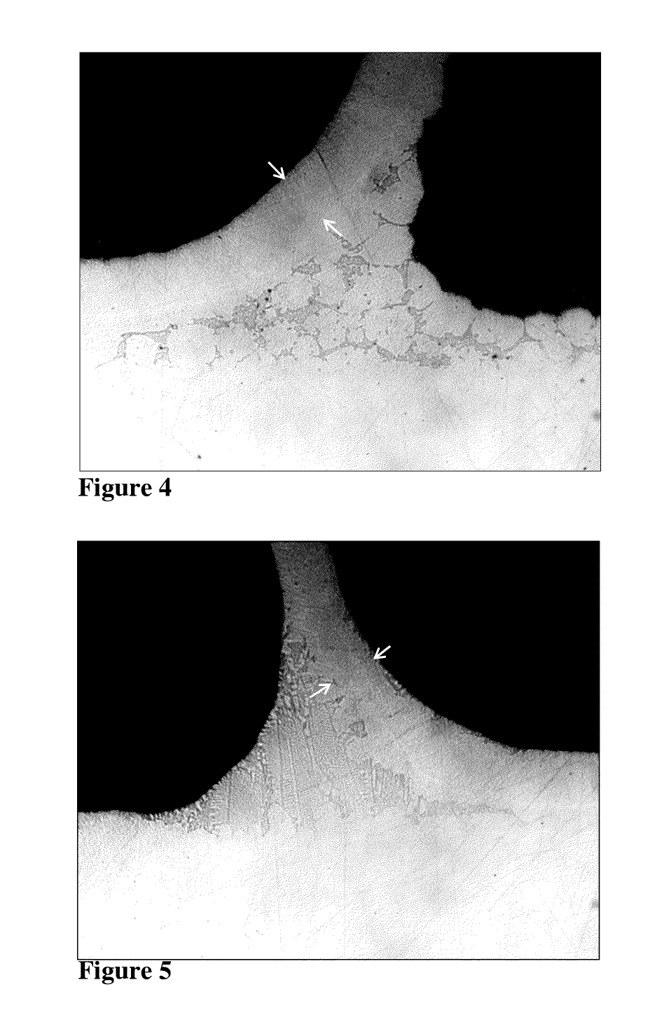

FIG. 4 is a photomicrograph of the inventive brazing filler metal powder joining the stainless steel parts, and FIG. 5 is a photomicrograph of the comparative brazing filler metal powder joining the two stainless steel parts. After the brazing process, the thin stainless steel tube of FIG. 4 had a wall thickness equal to about 93% of the wall thickness prior to the brazing process, while the thin stainless steel tube of FIG. 5 had a wall thickness equal to about 73% of the wall thickness prior to the brazing process. Thus, the experiment results indicate the inventive brazing filler metal powder provides significantly less erosion during the brazing process.

This experiment indicates that the cobalt present in the inventive brazing filler metal powder provided a diffusion reservoir and thus a diffusion path alternative to the diffusion path provided by the stainless steel part. Thus, when the brazing filler metal powder was heated to liquid state, a significant amount of the alloy elements from the first metal particles diffused into the cobalt, rather than into the stainless steel base metal part. In conclusion, it was found that the cobalt addition reduced the amount of diffusion into the base metal part, which in turn reduced erosion.

Experiment 2

A second experiment was conducted to compare the erosion resistance provided by three of the inventive brazing filler metal powders to the erosion resistance provided by Nicrobraz®152. The inventive brazing filler metal powders tested in the second experiment included Compositions F, G, and H of Table 2. Each brazing filler metal powder was heated to a temperature of 2,100° F. and used to braze two stainless steel parts together. In each case, one of the stainless steel parts was a thin tube having a thickness of only 0.003 inch. The wall thickness of the tube was measured before and after the brazing process, and the difference in wall thickness indicated the extent of erosion during the brazing process. The experiment results indicated that Compositions F, G, and H provide less erosion on the stainless steel parts, compared to Nicrobraz®152. After brazing, the tube brazed with Nicrobraz®152 had a wall thickness equal to about 58% of the original thickness, while the tube brazed with Composition F had a wall thickness equal to about 63% of the original thickness, the tube brazed with Composition G had a wall thickness equal to about 66% of the original thickness, and the tube brazed with Composition H had a wall thickness equal to about 69% of the original thickness.

Experiment 3

A third experiment was conducted wherein the tensile properties of an inventive brazing filler metal powder, specifically Composition H of Table 2, was compared to the tensile properties of a comparative brazing filler metal powder, specifically Nicrobraz®33, which had a particle size of not greater than 0.0098 inch. Prior to the tensile testing, Composition H and Nicrobraz®33 were used to braze two stainless steel parts together at a brazing temperature of 2000° F. The tensile testing was conducted on the braze joint at room and also at a temperature of 1670° F. Table 3 includes the results of the tensile testing.

TABLE 3

| | Tensile Test @ | | | | | |
|---|---|---|---|---|---|---|
| | Room Temp | | | Tensile Test @ 1670° F. | | |
| | | | Reduction | | | Reduction |
| Brazing Metal | UTS | Elong. | in | UTS | Elong. | in |
| Composition | (ksi) | (%) | Area (%) | (ksi) | (%) | Area (%) |
| Nicrobraz ® | 33.9 | 2.7 | 1.6 | 19.2 | 31.0 | 29.0 |
| 33 | | | | | | |
| Composition H | 35.9 | 2.7 | 4.7 | 15.8 | 35.8 | 25.4 |

The tensile testing results illustrate that Composition H provides a greater ultimate tensile strength, equivalent elongation, and lower reduction in area at room temperature than Nicrobraz®33. The tensile testing results also illustrate that Composition H provides a slightly lower ultimate tensile strength at 1670° F., but greater elongation and lower reduction in area than Nicrobraz®33.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A brazing filler metal powder, comprising:
a plurality of first metal particles including 13.0 wt. % to 45.0 wt. % chromium, 0.0 wt. % to 12.0 wt. % phosphorous, 0.0 wt. % to 12.0 wt. % silicon, 0.0 wt. % to 6.0 wt. % boron, 0.0 wt. % to 15.0 wt. % iron, and at least 41.0 wt. % nickel, based on the total weight of the first metal particles;
a plurality of second metal particles combined with the first metal particles and consisting of at least one of copper, molybdenum, cobalt, chromium, and alloys thereof;
the first metal particles and the second metal particles having a particle size of not greater than 0.0098 inch; and
wherein the first metal particles and the second metal particles are distinct from one another and are less than fully alloyed together.

2. The brazing filler metal powder of claim 1 including 70.0 wt. % to 95.0 wt. % of the first metal particles and 1.0 wt. % to 30.0 wt. % of the second metal particles, based on the total weight of the brazing filler metal powder.

3. The brazing filler metal powder of claim 1, wherein the second metal particles include cobalt and the brazing filler metal powder includes 1.0 wt. % to 25.0 wt. % cobalt, based on the total weight of the brazing filler metal powder.

4. The brazing filler metal powder of claim 3, wherein the second metal particles consist of cobalt.

5. The brazing filler metal powder of claim 1, wherein the second metal particles include molybdenum, and the brazing filler metal powder includes 1.0 wt. % to 25.0 wt. % molybdenum, based on the total weight of the brazing filler metal powder.

6. The brazing filler metal powder of claim 1, wherein the second metal particles include copper, and the brazing filler metal powder includes 1.0 wt. % to 25.0 wt. % copper, based on the total weight of the brazing filler metal powder.

7. The brazing filler metal powder of claim 1, wherein the first metal particles include at least 15.0 wt. % chromium, at least 3.0 wt. % phosphorous; at least 3.0 wt. % silicon;
less than 15.0 wt. % cobalt; and less than 15.0 wt. % iron, based on the total weight of the first metal particles

8. The brazing filler metal powder of claim 1, wherein the first metal particles include iron, and the brazing filler metal powder includes 5.0 wt. % to 25.0 wt. % iron, based on the total weight of the brazing filler metal powder.

9. The brazing filler metal powder of claim 1 consisting of:
26.1 wt. % chromium,
5.4 wt. % phosphorous,
5.9 wt. % silicon,
10.0 wt. % cobalt, and
a balance essentially of nickel, based on the total weight of the brazing filler metal powder

10. The brazing filler metal powder of claim 1, wherein the second metal particles consist of cobalt, and the brazing filler metal powder is capable of achieving an ultimate tensile strength of 35.9 ksi, elongation of 2.7%, and an area reduction of 4.7% at room temperature after being heated to a brazing temperature of 2,000° F.

11. The brazing filler metal powder of claim 1, wherein the second metal particles consist of cobalt, and the brazing filler metal powder is capable of achieving an ultimate tensile strength of 15.8 ksi, an elongation of 35.8%, and an area reduction of 25.4% at 1670° F. after being heated to a brazing temperature of 2000° F.

12. The brazing filler metal powder of claim 1, wherein the first metal particles and the second metal particles are combined by mixing the first metal particles and the second metal particles each having a particle size of not greater than 0.0098 inch.

13. The brazing filler metal powder of claim 1, wherein the first metal particles and the second metal particles are agglomerated together with a binding agent.

14. The brazing filler metal powder of claim 1, wherein the first metal particles and the second metal particles are sintered together.

15. The brazing filler metal powder of claim 1, wherein the first metal particles and the second metal particles are combined by milling.

16. A brazing material for brazing stainless steel parts, comprising:
a brazing filler metal powder including a plurality of first metal particles including 13.0 wt. % to 45.0 wt. % chromium, 0.0 wt. % to 12.0 wt. % phosphorous, 0.0 wt. % to 12.0 wt. % silicon, and at least 41.0 wt. % nickel, based on the total weight of the first metal particles; the first metal particles having a particle size of not greater than 0.0098 inch;
the brazing filler metal powder further including plurality of second metal particles combined with the first metal particles and consisting of at least one of copper, molybdenum, cobalt, chromium, and alloys thereof; the second metal particles having a particle size of not greater than 0.0098 inch;
wherein the first metal particles and the second metal particles are distinct from one another and are less than fully alloyed together; and
a binder combined with the brazing filler metal powder.

17. The brazing material of claim 16, wherein the binder includes at least one of a gel or an acrylic.

18. The brazing material of claim 16, wherein the brazing material is in the form of a paste, transfer tape, or transfer sheet.

19. The brazing material of claim 18, wherein the brazing material is in the form of a paste; the brazing material comprises 70.0 to 95.0 wt. % brazing filler metal powder and a balance essentially of the binder, based on the total weight of the brazing material; and wherein the binder includes a gel.

20. The brazing material of claim 18, wherein the brazing material is in the form of a transfer tape or sheet; the brazing material comprises at least 75.0 wt. % brazing filler metal powder and a balance essentially of the binder, based on the total weight of the brazing material;
and wherein the binder includes an acrylic.

21. A brazed assembly, comprising
a first metal part formed of stainless steel;
a second metal part formed of stainless steel and joined to the first metal part by a brazing filler metal powder;
the brazing filler metal powder comprising a plurality of first metal particles including 13.0 wt. % to 45.0 wt. % chromium, 0.0 wt. % to 12.0 wt. % phosphorous, 0.0 wt. % to 12.0 wt. % silicon, 0.0 wt. % to 6.0% boron, 0.0 wt. % to 15.0 wt. % iron, and at least 41.0 wt. % nickel, based on the total weight of the first metal particles;
a plurality of second metal particles combined with the first metal particles and consisting of at least one of copper, molybdenum, cobalt, chromium, and alloys thereof;
the first metal particles and the second metal particles having a particle size of not greater than 0.0098 inch; and
wherein the first metal particles and the second metal particles are distinct from one another and are less than fully alloyed together.

22. The brazed assembly of claim 21, wherein at least one of the first metal part and the second metal part has a thickness of not greater than 0.003 inch.

23. The brazed assembly of claim 21, wherein the brazed assembly is a heat exchanger.

24. A method of forming a brazing filler metal powder, comprising the steps of:
providing a plurality of first metal particles including 13.0 wt. % to 45.0 wt. % chromium, 0.0 wt. % to 12.0 wt. % phosphorous, 0.0 wt. % to 12 wt. % silicon, 0.0 wt. % to 6.0% boron, 0.0 wt. % to 15.0 wt. % iron, and at least 41.0 wt. % nickel, based on the total weight of the first metal particles; the first metal particles having a particle size of not greater than 0.0098 inch;
providing a plurality of second metal particles consisting of at least one of copper, molybdenum, cobalt, chromium, and alloys thereof;
combining the first metal particles with the second metal particles; and
processing the combined first metal particles and second metal to a particle size of not greater than 0.0098 inch.

25. The method of claim 24, wherein the first metal particles and the second metal particles are distinct from one another and are less than fully alloyed together after the combining step.

26. The method of claim 24, wherein the combining step includes spray drying the first metal particles and the second metal particles with a binding agent.

27. The method of claim 24, wherein the combining step includes mixing the first metal particles and the second metal particles, wherein the first metal particles and the second metal particles are solid and dry during the mixing step.

28. The method of claim 27, wherein the mixing step includes mixing the first metal particles and the second metal particles with a binding agent in a batch mixer.

29. The method of claim 24, wherein the combining step includes sintering the first metal particles and the second metal particles together.

30. The method of claim 29, wherein the sintering step is conducted in a vacuum at a pressure of not greater than 10⁻³ torr and a temperature of 1,300° F. to 1,800° F.

31. The method of claim 24, wherein the combining step includes milling the first metal particles and the second metal particles.

32. The method of claim 24, including providing a first metal and a second metal, and processing the first metal and the second metal to the plurality of first metal particles and the plurality of second metal particles having a particle size of not greater than 0.0098 inch.

33. A method of forming a brazing material for brazing stainless steel parts, comprising the steps of:
providing a brazing filler metal powder, the brazing filler metal powder comprising a plurality of first metal particles combined with a plurality of second metal particles; the first metal particles including 13.0 wt. % to 45.0 wt. % chromium, 0.0 wt. % to 12.0 wt. % phosphorous, 0.0 wt. % to 12.0 wt. % silicon, 0.0 wt. % to 6.0 wt. % boron, 0.0 wt. % to 15.0 wt. % iron, and at least 41.0 wt. % nickel, based on the total weight of the first metal particles; the second metal particles consisting of at least one of copper, molybdenum, cobalt, chromium, and alloys thereof; the first metal particles and the second metal particles having a particle size of not greater than 0.0098 inch; wherein the first metal particles and the second metal particles are distinct from one another and are less than fully alloyed; and
combining the brazing filler metal powder with a binder.

34. The method of claim 33, wherein the combining step includes forming a paste, transfer tape, or transfer sheet.

35. A method of forming a brazed assembly, comprising the steps of:
brazing a first metal part formed of stainless steel to a second metal part formed of stainless steel with a brazing filler metal powder;
the brazing filler metal powder comprising a plurality of first metal particles including 13.0 wt. % to 45.0 wt. % chromium, 0.0 wt. % to 12.0 wt. % phosphorous, 0.0 wt. % to 12.0 wt. % silicon, 0.0 wt. % to 6.0 wt. % boron, 0.0 wt. % to 15.0 wt. % iron, and at least 41.0 wt. % nickel, based on the total weight of the first metal;
a plurality of second metal particles combined with the first metal particles and consisting of at least one of copper, molybdenum, cobalt, chromium, and alloys thereof;
the first metal particles and the second metal particles having a particle size of not greater than 0.0098 inch; and
wherein the first metal particles and the second metal particles are distinct from one another and are less than fully alloyed together prior to the brazing step.

36. The method of claim 35, wherein at least one of the first metal part and the second metal part has a thickness less than 0.010 inch.

37. The method of claim 35, wherein the brazing step is conducted in an atmosphere controlled furnace.

38. The method of claim 35, wherein the brazing step includes melting the brazing filler metal powder between the first metal part and the second metal part; the first metal particles of the brazing filler metal powder including silicon; and wherein the second metal particles of the brazing filler metal powder provide a diffusion reservoir for the alloy elements of the first metal particles during the brazing step.
